(19) United States
(12) Patent Application Publication
(10) Pub. No.: US 2016/0364635 A1
(43) Pub. Date: Dec. 15, 2016

(54) IMAGE FORMING APPARATUS AND PRINTING METHOD

(71) Applicants: KABUSHIKI KAISHA TOSHIBA, Tokyo (JP); TOSHIBA TEC KABUSHIKI KAISHA, Tokyo (JP)

(72) Inventor: Osamu Namura, Yokohama (JP)

(21) Appl. No.: 14/739,403

(22) Filed: Jun. 15, 2015

(51) Int. Cl. G06K 15/02

(52) U.S. Cl. CPC G06K 15/18; G06K 15/027

(57) ABSTRACT

In accordance with one embodiment, an image forming apparatus comprises a printing section configured to be capable of carrying out at least a decoloring printing; an input section configured to receive a command from a user; a first print control section configured to control, in a case of receiving a printing command from the user, the printing section to decolor and print a printing subject image, and then wait until the command is input from the user; and a second print control section configured to control, in a case of receiving a command continuing printing from the user, the printing section to print the printing subject image.

### FIELD

Embodiments described herein relate generally to an image forming apparatus and a printing method.

### BACKGROUND

There is known an apparatus equipped with a test printing function. A test printing is a printing for confirming a printing result in advance.

There is a case in which the result of the test printing does not meet the intended result of a user. In a case, a sheet on which the test printing is carried out is totally wasted.

### BRIEF DESCRIPTION OF THE DRAWINGS

FIG. 1 is a diagram illustrating a printing system equipped with an image forming apparatus according to an embodiment;

FIG. 2 is a block diagram of the image forming apparatus;

FIG. 3 is a diagram illustrating an example of the image forming apparatus;

FIG. 4 is a block diagram illustrating the functions of a control section;

FIG. 5 is a flowchart of a printing processing;

FIG. 6 is a flowchart of a test printing processing;

FIG. 7 is a sheet on which a mark is printed in a stapled scheduled place;

FIG. 8 is a sheet on which circles are printed in a drilled scheduled place;

FIG. 9 is an example of a confirmation screen;

FIG. 10 is an example of a printing setting screen; and

FIG. 11 is a sheet on which a dashed line is printed in a bent scheduled place.

### DETAILED DESCRIPTION

In accordance with an embodiment, an image forming apparatus comprises a printing section configured to be capable of carrying out at least a decoloring printing; an input section configured to receive a command from a user; a first print control section configured to control, in a case of receiving a printing command from the user, the printing section to decolor and print a printing subject image, and then wait until the command is input from the user; and a second print control section configured to control, in a case of receiving a command continuing printing from the user after the decoloring printing, the printing section to print the printing subject image.

Herein, the embodiment of the present invention is described with reference to the accompanying drawings. The same or equivalent components are indicated with the same reference numerals in figures.

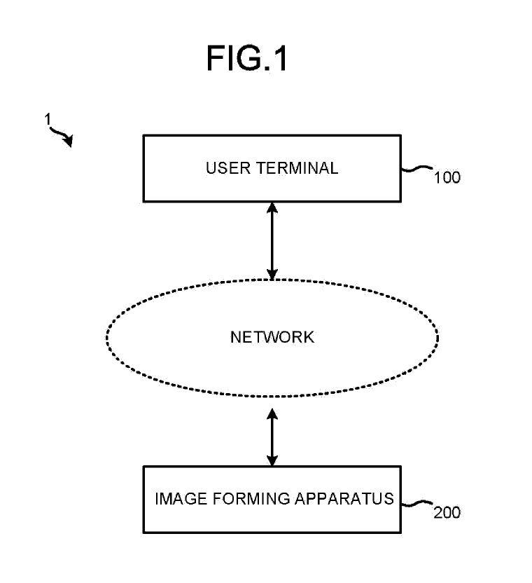

FIG. 1 is a diagram illustrating a printing system equipped with the image forming apparatus according to the embodiment. The printing system 1 includes a user terminal 100 and an image forming apparatus 200. The user terminal 100 and the image forming apparatus 200 are connected with each other via a network.

The user terminal 100 is a user operation terminal such as a personal computer and the like. The user terminal 100 communicates with the image forming apparatus 200 according to an instruction of the user.

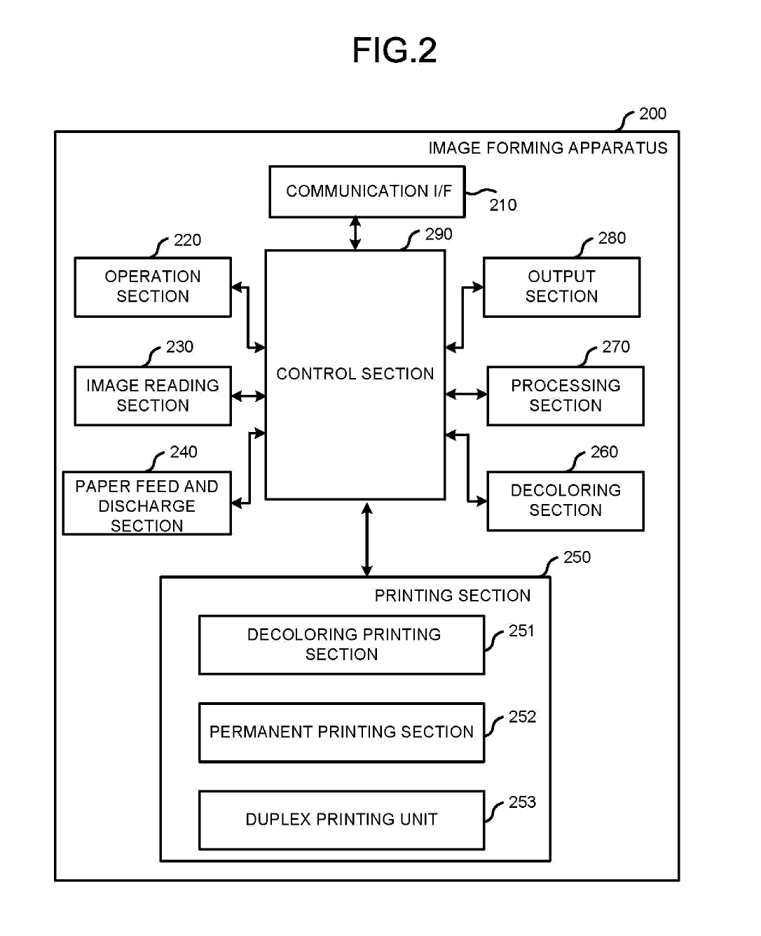

The image forming apparatus 200 is a printing device such as a copier and the like. The image forming apparatus 200 is equipped with, as shown in FIG. 2, a communication interface 210, an operation section 220, an image reading section 230, a paper feed and discharge section 240, a printing section 250, a decoloring section 260, a processing section 270 and an output section 280.

The communication interface 210 is a network connection interface for connecting the image forming apparatus 200 to the network. The communication interface 210 functions as an input section for receiving the printing command from the user who operates the user terminal 100. The communication interface 210 communicates with the user terminal 100 under the control of a control section 290.

The operation section 220 is a user interface such as a button, a switch, a touch panel and the like. The operation section 220 functions as an input section for receiving the printing command from the user. The operation section 220 notifies the control section 290 of the input of the user.

The image reading section 230 is an image capturing device such as a scanner, a camera and the like. The image forming apparatus 200 includes an automatic document feeder 232 which conveys sheets one by one loaded on a paper feed tray 231 to the image reading section 230. The image reading section 230 reads images from the sheets conveyed from the automatic document feeder 232 under the control of the control section 290.

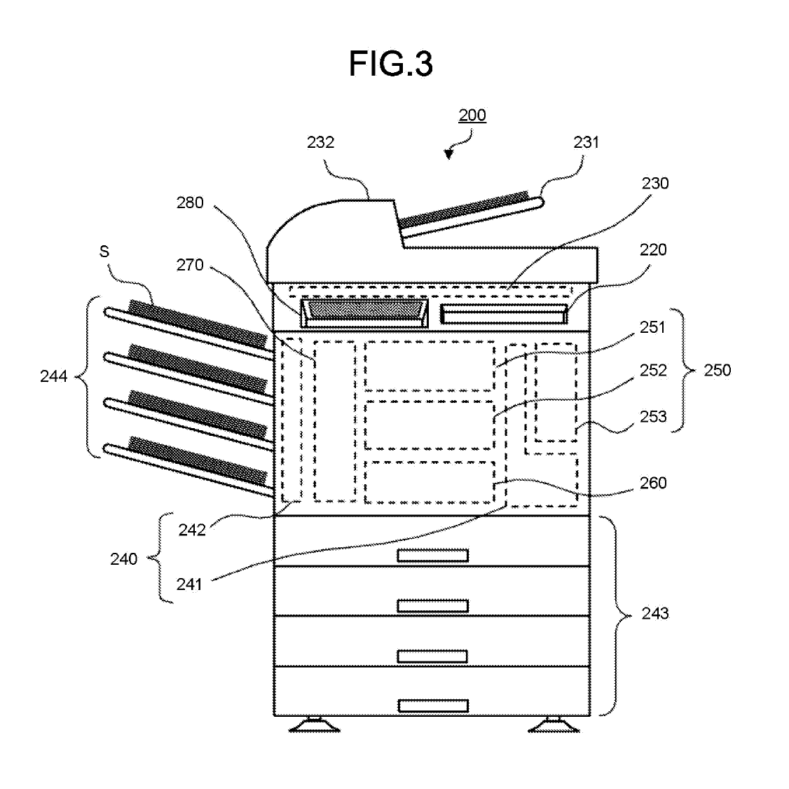

The paper feed and discharge section 240 is a device for feeding paper and discharging paper. FIG. 3 is an example of the image forming apparatus 200. The paper feed and discharge section 240 is equipped with a paper feed section 241 and a paper discharge section 242. The paper feed section 241 supplies sheets loaded on the paper feed tray 243 to the printing section 250. The image forming apparatus 200 includes a stacker 244 constituted by a plurality of paper discharge trays. The paper discharge section 242 discharges the sheet printed by the printing section 250 to anyone of the plurality of paper discharge trays.

The printing section 250 is a printing unit for carrying out printing on the sheet. The printing section 250 is equipped with a decoloring printing section 251, a permanent printing section 252 and a duplex printing unit 253.

The decoloring printing section 251 is a printing unit for printing an image on the sheet with the use of a decoloring ink. The decoloring printing section 251 is a first printing section of the image forming apparatus 200. The decoloring ink is an ink used for decoloring color through heat, light or chemical processing. For example, the decoloring ink is an ink discolored by means of applying heat more than a predetermined temperature (hereinafter, referred to as a “decoloring temperature”), emitting light including predetermined wavelength components such as ultraviolet and the like, and coating the ink containing predetermined components. Further, the decoloring ink contains not only a liquid ink, but also a powdered ink. The powdered decoloring ink can be rephrased as a decolorable toner. Hereinafter, a printing using the decoloring ink is called as a decoloring printing.

The decoloring printing section 251 is, for example, an electrophotographic type printing unit used in a laser printer or an LED (Light Emitting Diode) printer. The decoloring printing section 251 is equipped with an image carrier such as a photoconductive drum and the like, a transfer section which transfers a toner image developed on the image carrier to the sheet and a fixing section which fixes the toner image transferred to the sheet on the sheet through heating and pressure. The fixing section is constituted by a heat roller for heating to a fixing temperature and a pressure roller for applying pressure on the sheet.

The permanent printing section 252 is a printing unit for printing the image on the sheet with the use of a permanent ink. The permanent printing section 252 is a second printing section of the image forming apparatus 200. The permanent ink, which is not the decoloring ink, is a general ink. Further, the permanent ink contains not only the liquid ink, but also the powdered ink. The powdered ink can be rephrased as a permanent toner. Hereinafter, a printing using the permanent ink is called as a permanent printing.

The permanent printing section 252 is, for example, an electrophotographic type printing unit. The permanent printing section 252 is equipped with the image carrier, the transfer section and the fixing section similar to the decoloring printing section 251. Further, part of the decoloring printing section 251 may be the same mechanisms as that of the permanent printing section 252. For example, the decoloring printing section 251 and the permanent printing section 252 may both have the image carrier, the transfer section and the fixing section.

The duplex printing unit 253 is a unit for reversing the sheet. The duplex printing unit 253 enables the decoloring printing section 251 to print one side of the sheet and enables the permanent printing section 252 to print the other side of the sheet to realize the duplex printing of the sheet.

The decoloring section 260 uses the decoloring ink to erase the formed image (hereinafter referred to as a “decoloring image”) from the sheet. For example, the decoloring section 260 is equipped with the heat roller for heating to the decoloring temperature and the pressure roller for applying the pressure on the sheet. The decoloring section 260 heats the sheet to erase the decoloring image on the sheet. Further, in a case in which the printing section 250 is the electrophotographic type printing unit, the fixing section contained in the printing section 250 may have the functions of the decoloring section 260. That is, the decoloring section 260 and the fixing section contained in the printing section 250 are the common mechanisms.

The processing section 270 processes the sheet printed by the printing section 250. The processing section 270 includes, for example, a stapler for stapling the sheet and a hole puncher for drilling the sheet. The processing section 270 staples or drills the sheet under the control of the control section 290.

The output section 280 outputs various kinds of information to the user. For example, the output section 280 is a display device such as a liquid crystal display and the like, or a sound generator such as a speaker and the like.

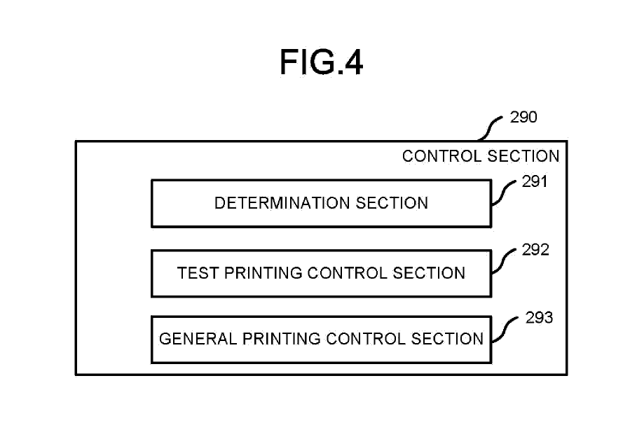

The control section 290 is a processing device such as a processor and the like. The control section 290 functions as a control device controlling the image forming apparatus 200. The control section 290 operates according to programs stored in an ROM (Read Only Memory) and an RAM (Random Access Memory) (not shown) to realize various operations containing a later described printing processing. The control section 290 operates according to the programs to function as a determination section 291, a test printing control section 292 and a general printing control section 293 as shown in FIG. 4. The control section 290 may be constituted by one processor or a plurality of processors. In a case of constituting the control section 290 with the plurality of processors, the control section 290 may realize the printing processing through cooperation with the plurality of processors.

Next, the operations of the image forming apparatus 200 with such a constitution are described.

If receiving the printing command from the user, the control section 290 starts the printing processing. The printing command is sent from the user terminal 100 or the operation section 220. For example, if the user sets a document on the paper feed tray 231 and presses a copy start button in the operation section 220, the image reading section 230 scans the document, and the operation section 220 sends the printing command of the scanned image for the control section 290. Further, if the user selects the printing subject image on the user terminal 100 and presses the print start button displayed on the user terminal 100, the user terminal 100 sends the printing command of the selected image to the control section 290 through the network. In the following description, image information and printing setting information are contained in the printing command.

The image information is the information of the printing subject image. If the printing command is sent from the operation section 220, the image information is the image scanned by the image reading section 230. If the printing command is sent from the user terminal 100, the image information is the image selected as a print target by the user on the user terminal 100.

The printing setting information is the information in which the setting of the printing executed by the general printing control section 293 is recorded. For example, the printing setting information is the information for determining that the printing executed by the general printing control section 293 is either the duplex printing or a simplex printing, and either the decoloring printing or the permanent printing. The printing setting is not limited to the information. For example, in the printing setting, the information for determining how many copies the number of print copies is, whether or not the processing of the sheet is executed, and whether or not the test printing is executed may be contained.

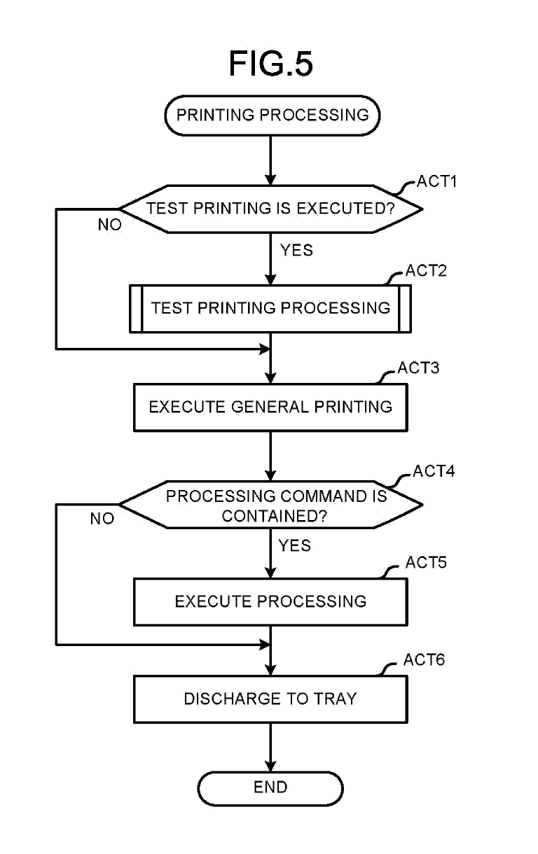

Hereinafter, the printing processing is described with reference to the flowchart in FIG. 5.

First, the determination section 291 determines whether or not the test printing is executed based on the setting information (ACT 1). If the test printing is not executed (NO in ACT 1), the processing in ACT 3 is carried out.

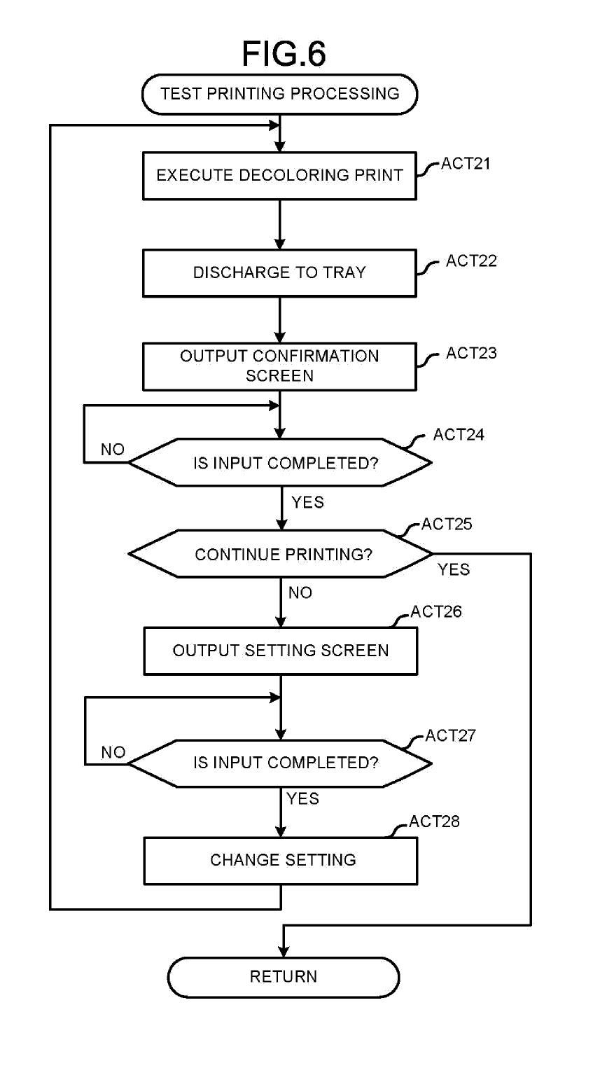

If the test printing is executed (YES in ACT 1), the test printing control section 292 starts the test printing processing (ACT 2). Hereinafter, the test printing processing is described with reference to the flowchart in FIG. 6.

First, the test printing control section 292 controls the decoloring printing section 251 to decolor and print the printing subject image (ACT 21). In a case in which the printing setting is turned into the duplex printing, the test printing control section 292 controls the duplex printing unit 253 to print image on the two sides of the sheet. The test printing control section 292, even if the printing setting is turned into the setting for printing multiple copies, prints only one copy without printing multiple copies.

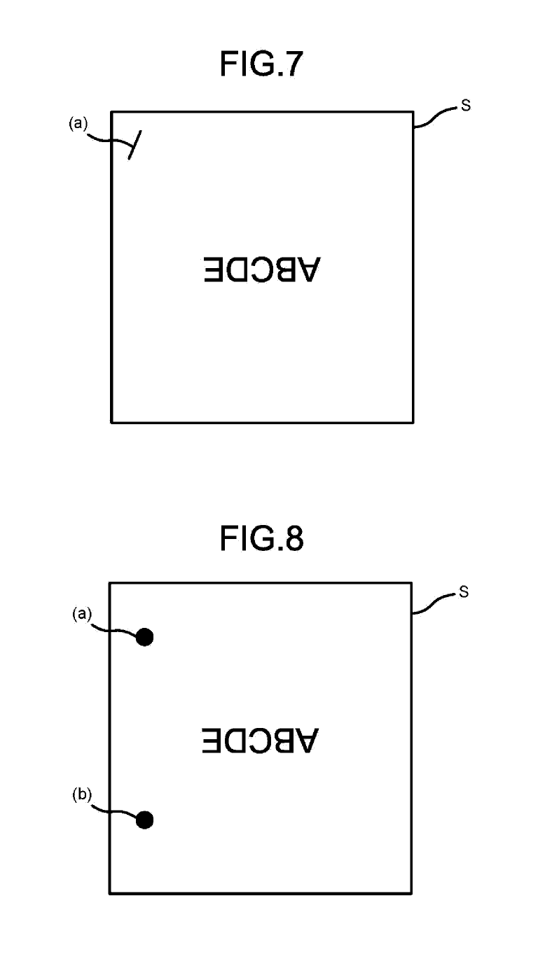

The test printing control section 292, even if the printing setting is turned into the setting for processing the sheet, does not process the sheet S and prints a mark at a scheduled place processed by the general printing control section 293 later. For example, if the printing setting is the stapling setting, the test printing control section 292 prints a line of which the length is the same as the staple, as (a) shown in FIG. 7, at a scheduled place stapled by the general printing control section 293. Further, if the printing setting is the setting for drilling the sheet, the test printing control section 292 prints circles of which the size is the same as punch holes, as (a) and (b) shown in FIG. 8, at a scheduled place drilled by the general printing control section 293.

If the decoloring printing is completed, the test printing control section 292 controls the paper discharge section 242 to discharge the sheet to any paper discharge tray on the stacker 244 (ACT 22).

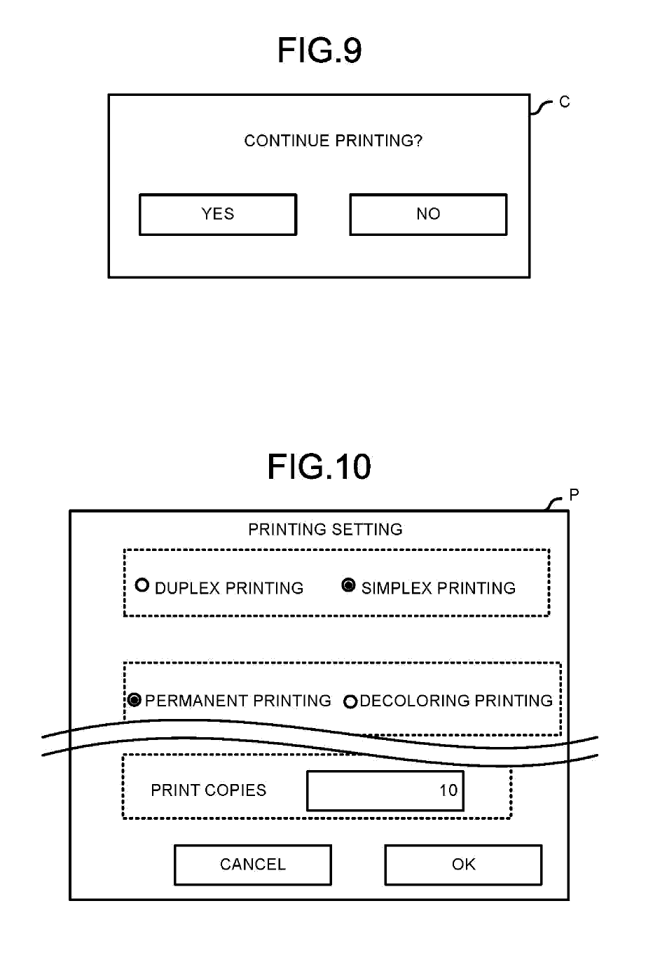

Next, the test printing control section 292 outputs a confirmation screen C to the output section 280 (ACT 23). The confirmation screen C is a screen for confirming whether or not the printing in the current printing setting is continued towards the user. The FIG. 9 is an example of the confirmation screen C. If the printing command is sent from the operation section 220, the test printing control section 292 displays the confirmation screen C on the output section 280. If the printing command is sent from the user terminal 100, the test printing control section 292 commands the user terminal 100 to display the confirmation screen C on the display.

The test printing control section 292 determines whether or not there is an input from the user (ACT 24). In the example of FIG. 9, the test printing control section 292 determines whether a “YES” button is pressed or a “NO” button is pressed by the user. If there is no input from the user (NO in ACT 24), the test printing control section 292 repeats the processing in ACT 24 until there is the input from the user.

If there is the input from the user (YES in ACT 24), the test printing control section 292 determines that the input from the user is either a printing continuation command or a printing interruption command (ACT 25). The printing continuation command is a command to continue the printing in the current printing setting. In the example of FIG. 9, when the user presses the “YES” button, the printing continuation command is sent to the control section 290 from the operation section 220 or the user terminal 100. The printing interruption command is a command to interrupt the printing. In the example of FIG. 9, when the user presses the “NO” button, the printing interruption command is sent to the control section 290 from the operation section 220 or the user terminal 100.

If the input from the user is the printing continuation command (YES in ACT 25), the test printing control section 292 terminates the test printing processing and returns the flowchart in FIG. 5.

In FIG. 7 and FIG. 8, the position of the staple and the position of the punch hole are unnatural. In this case, the user inputs the printing interruption command. In a case in which the input from the user is the printing interruption command (NO in ACT 25), the test printing control section 292 outputs a printing setting screen P to the output section 280 (ACT 26). The printing setting screen P is a screen for changing the printing setting. FIG. 10 is an example of the printing setting screen P. If the printing command is sent from the operation section 220, the test printing control section 292 displays the printing setting screen P on the output section 280. If the printing command is sent from the user terminal 100, the test printing control section 292 commands the user terminal 100 to display the printing setting screen P on the display.

The test printing control section 292 determines whether there is an input from the user (ACT 27). In the example of FIG. 10, the test printing control section 292 determines whether the “OK” button is pressed by the user. If there is no input from the user (NO in ACT 27), the test printing control section 292 repeats the processing in ACT 27 until there is the input from the user.

If there is the input from the user (YES in ACT 27), the test printing control section 292 changes the printing setting according to the information input to the printing setting screen P (ACT 28). If the changing of the setting is completed, the test printing control section 292 returns the processing in ACT 21, and decolors and prints the image in the changed printing setting again.

Return to FIG. 5. The general printing control section 293 prints the image according the printing setting (ACT 3). If the printing setting is changed in ACT 28, the image is printed in the changed printing setting. If the printing setting is the permanent printing, the general printing control section 293 controls the permanent printing section 252 to carry out the permanent printing for the image. If the printing setting is the decoloring printing, the general printing control section 293 controls the decoloring printing section 251 to decolor and print the image.

The general printing control section 293 determines whether or not the printing setting is turned into the setting for processing the sheet (ACT 4). In a case in which the printing setting is not the processing setting (NO in ACT 4), the general printing control section 293 carries out the processing in ACT 6.

In a case in which the printing setting is the processing setting (YES in ACT 4), the general printing control section 293 controls the processing section 270 to process the sheet (ACT 5). For example, if the printing setting is the setting for stapling the sheet, the general printing control section 293 controls the stapler of the processing section 270 to staple the sheet. If the printing setting is the setting for drilling the sheet, the general printing control section 293 controls the hole puncher of the processing section 270 to drill the sheet.

If the printing is completed, the general printing control section 293 controls the paper discharge section 242 to discharge the sheet to the stacker 244 (ACT 6). If the multiple copies are printed, the general printing control section 293 discharges each one copy to another paper discharge tray. If the discharge is completed, the control section 290 terminates the printing processing.

In accordance with the present embodiment, the test printing is the decoloring printing. Therefore, in a case in which the result of the test printing does not meet the intended result of the user, the user decolors the sheet and recycles the decolored sheet. And thus, the user does not waste the sheet through the test printing.

The each embodiment described above shows an example, and various modifications and applications are possible.

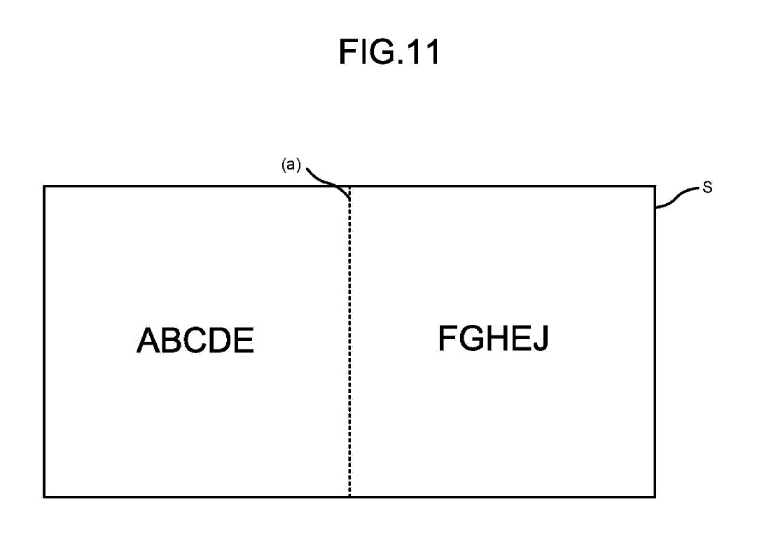

For example, in the embodiment described above, the processing section 270 is equipped with the stapler and the hole puncher; however, the processing section 270 may be equipped with a folding mechanism for bending the sheet. After the general printing control section 293 controls to print the image on the sheet, the processing section 270 bends the sheet based on the control of the general printing control section 293. At this time, the test printing control section 292 does not control to bend the sheet during the test printing, and controls to print a mark at a scheduled place where the general printing control section 293 controls to bend the sheet. For example, the test printing control section 292 controls to print a dashed line, as (a) shown in FIG. 11, at the scheduled place where the general printing control section 293 controls to bend the sheet. The processing section 270, which bends a plurality of sheets once, may be a binding mechanism for stapling the bent place. The binding mechanism is one form of the folding mechanism.

Further, the test printing control' section 292, before executing the discoloring printing in ACT 21, controls the decoloring section 260 to decolor the sheet used in the test printing. The presence/absence of the execution of the decoloring processing may be determined based on the printing setting contained in the printing command. The test printing control section 292 picks up the sheet from a predetermined paper feed tray of the plurality of paper feed trays 243 to decolor the picked-up sheet, and sequentially, the test printing may be executed on the sheet subjected to the decoloring processing. The tray in which the sheet is picked up is, for example, a tray (hereinafter, referred to as a “designation tray”) decided by the user when the sheet subjected to test printing is stored therein after the determination of the printing result. By simply storing the sheet subjected to test printing in the designation tray as it is, the decoloring processing and the test printing are automatically executed, and thus the time of the user can be saved.

The test printing control section 292 may be constituted by notifying the user that the printed sheet is the sheet subjected to test printing in order that the user does not wrongly use the sheet subjected to the test printing.

For example, the test printing control section 292, when discharging the sheet to the paper discharge tray in ACT 22, may control to output attention information to the output section 280. The attention information encourages the user to pay attention. For example, the attention information may indicate that the printed sheet is the sheet subjected to test printing, and may contain a message for encouraging the user to return the sheet to the designation tray after the confirmation of the printing result. The attention information may be character information displayed on the display, or may be a sound message output to a speaker. The attention information may be only a buzzer sound. In a case in which the printing command is sent from the user terminal 100, the test printing control section 292 may command the user terminal 100 to output the attention information.

Further, the test printing control section 292, when executing the discoloring printing in ACT 21, controls to print the attention information in addition to the printing subject image on the sheet. The attention information may be a character such as “Confidential” and the like. If the printing setting is the setting of the duplex printing, the attention information is printed on a surface opposite to a surface on which the printing subject image is printed. At this time, the test printing control section 292 may decolor and print either the printing subject image or the attention information, or may take the printing of the printing subject image as the decoloring printing and take the printing of the attention information as the permanent printing. Although the image on the discolored sheet is seemed to be disappeared, the discolorable toner is still left on the sheet. Therefore, in a case in which the user uses the sheet subjected to the test printing in the uses of the general printing and the like other than the test printing, it is afraid that the confidential information is revealed outside. However, because the printing of the attention information is the permanent printing, even if the user decolors the sheet, the attention information is not disappeared from the sheet. Thus, a miss, that is, the user mistakes the sheet subjected to the test printing and uses the sheet subjected to the test printing in the other uses other than the test printing, can be reduced.

In the embodiment described above, the printing section 250 is described as the electrophotographic type printing unit; however, the printing section 250 may be an inkjet system, a thermal system, a dot impact system and the like, and may be a printing unit other than the electrophotographic type.

The image forming apparatus 200 is described as the copier; however, the image forming apparatus 200 may be not equipped with a copy function, and only a printer.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. An image forming apparatus, comprising:
a printing section configured to be capable of carrying out at least a decoloring printing;
an input section configured to receive a command from a user;
a first print control section configured to control, in a case of receiving a printing command from the user, the printing section to decolor and print a printing subject image, and then waits until the command is input from the user; and
a second print control section configured to control, in a case of receiving a command continuing printing from the user after the decoloring printing, the printing section to print the printing subject image.

2. The image informing apparatus according to claim 1, wherein
the printing section is equipped with a first printing section configured to be capable of carrying out the decoloring printing and a second printing section configured to be capable of carrying out a permanent printing; wherein
the first print control section controls, in a case of receiving the printing command from the user, the first printing section to decolor and print the printing subject image, and then waits for the command from the user; and
the second print control section controls, in a case of receiving a command continuing printing from the user, the second printing section to carry out the permanent printing for the printing subject image.

3. The image forming apparatus according to claim 1, further comprising:
a processing section configured to process a sheet on which the printing subject image is printed; wherein
the second print control section controls the processing section to process the sheet in a case in which a processing command to process the sheet is contained in the printing command and after printing the printing subject image on the sheet; and
the first print control section does not process the sheet at a scheduled place processed by the second print control section, and decolors and prints a preset mark.

4. The image forming apparatus according to claim 3, wherein
the processing section includes a stapler which staples the sheet; wherein
the second print control section controls the processing section to staple the sheet in a case in which a command to staple the sheet is contained in the printing command and after printing the printing subject image on the sheet; and
the first print control section does not staple the sheet at a scheduled place stapled by the second print control section, and decolors and prints a preset mark.

5. The image forming apparatus according to claim 3, wherein
the processing section includes a hole puncher which drills the sheet; wherein
the second print control section controls the processing section to drill the sheet in a case in which a command to drill the sheet is contained in the printing command and after printing the printing subject image on the sheet; and
the first print control section does not drill the sheet at a scheduled place drilled by the second print control section, and decolors and prints a preset mark.

6. The image forming apparatus according to claim 1, further comprising:
a discoloring section configured to decolor the sheet decolored and printed; wherein
the first print control section controls the decoloring section to decolor the sheet used in the decoloring printing before the printing subject image is discolored and printed.

7. The image informing apparatus according to claim 1, wherein
the first print control section prints attention information for encouraging the user to pay attention, in addition to the printing subject image, on the sheet on which the printing subject image is decolored and printed.

8. The image informing apparatus according to claim 7, wherein
the printing section may be a permanent printing, in addition to the decoloring printing; and
the first print control section controls to take the printing of the printing subject image as the decoloring printing, and take the printing of the attention information as the permanent printing.

9. The image informing apparatus according to claim 7, further comprising:
a duplex printing unit configured to enable the first print control section and the second print control section to carry out a duplex printing by rotating the sheet; wherein
the first print control section prints the attention information on a surface opposite to a surface on which the printing subject image is printed in a case in which the printing command is a command of the duplex printing.

10. A printing method, comprising:
controlling a printing section capable of carrying out at least a decoloring print to decolor and print a printing subject image in a case of receiving a printing command from a user, and then waiting until a command is input from the user; and
controlling a printing section to print the printing subject image in a case of receiving a command continuing a printing from the user after the decoloring printing.
